(19) United States
(12) Patent Application Publication
(10) Pub. No.: US 2023/0061017 A1
(43) Pub. Date: Mar. 2, 2023

(54) Convertible Keyboard

(71) Applicant: Design Enzyme LLC, Hong Kong (HK)

(72) Inventors: Gerald Nisperos, Hong Kong (HK); Matthew Sutter, Columbus, OH (US)

(21) Appl. No.: 17/984,411

(22) Filed: Nov. 10, 2022

Related U.S. Application Data
(63) Continuation-in-part of application No. 29/739,201, filed on Jun. 23, 2020.
Application No. 29/739,201 is a continuation-in-part of application No. 29/739,206, filed on Jun. 23, 2020.

(51) Int. Cl. G06F 3/02

(52) U.S. Cl. CPC G06F 3/0202

(57) ABSTRACT

The present invention is directed to a keyboard having a plurality of components that can be releasably attached to one another to enable expedited customization of the keyboard to a desired configuration. The keyboard includes a base and a plurality of keys. The keyboard may also include a plurality of adapters configured to be releasably attached to the base and/or the keys. One of the adapters is low-profile adapter, while another is a high-profile adapter. As such, the same keyboard can quickly and easily be customized from a low-profile keyboard to a high-profile keyboard, and then again to a low-profile keyboard. Additionally, various adapters may be releasably secured to the keyboard to create other visual appearances, including adapters having different colors, lighting effects, and the like. The adapters can be installed without use of tools and without disassembling the entire keyboard.

### CROSS-REFERENCE(S) TO RELATED APPLICATION(S)

The present application claims priority on U.S. Design patent application Ser. No. 29/739,201, filed Jun. 23, 2020 and entitled Convertible High-Profile and Low-Profile Keyboard, and U.S. Design patent application Ser. No. 29/739,206, filed Jun. 23, 2020 and entitled Convertible High-Profile and Low-Profile Keyboard, the entirety of both of which are hereby incorporated herein by reference.

### BACKGROUND OF THE INVENTION

### 1. Field of the Invention

The present invention relates in general to the field of electronic devices. More particularly, the present invention relates to electronic devices, such as keyboards used with a variety of computers, gaming systems and the like. Specifically, a preferred embodiment of the present invention relates to keyboards having multiple components that can be removed and replaced, resulting in different visual characteristics. By way of example and not limitation, the present invention is directed to keyboards having components that can be quickly and easily removed and replaced to create keyboards having a low-profile appearance, a high-profile appearance, and a variety of different color or other design, visual, or other appearances.

### 2. Discussion of the Related Art

Traditional computer keyboards are known in the art. With the evolution of computer technology, keyboard technology has similarly evolved. For instance, standard keyboard configurations have evolved over time to allow users to purchase keyboard configurations that are more custom tailored to a particular user's needs and desires. Similarly, keyboards have evolved to allow users to select and purchase preassembled keyboards having specific key layouts depending on how the keyboard will be used, including for word processing purposes, other work processes, coding, gaming, and the like. Typical keyboard configurations can include a full-sized keyboard, a tenkeyless (TKL) keyboard without the numeric pad, 65% keyboard without the numeric pad or the F keys, and a 75% keyboard without the numeric pad. Furthermore, customized keyboards have come into prominence based in part on computer gaming, which allow users to achieve a better functioning keyboard, while also providing unique personalization depending on a user's preferences and interests.

Additionally, keyboards can now be customized after purchase. A variety of different components may be customized, including the keys associated with a keyboard; components that support the keys to result in different sound, responsiveness, and the like; profiles components; color and light features; and the like. This requires a user to first purchase or otherwise acquire a keyboard having the general base, keys, and other components or characteristics, and then to purchase a variety of additional components that can be used to customize the preexisting keyboard. Oftentimes, this would require the purchase of multiple different customization kits that include a large number of pieces that can be expensive and burdensome to sort through. In other instances, users would need to purchase multiple keyboards and then mine the various components that achieved desired customization effects. Further, traditional customization kits required the original keyboard to be completely taken apart and reassembled with the customization pieces. This disassembly and reassembly could take hours to complete, with the risk of parts going missing. Further still, the disassembly and reassembly process oftentimes exposes various sensitive electrical components that are easily damaged, or in the worst case scenario, destroyed. In some instances, the damage or destruction to these components is not identified until after the keyboard has been reassembled and use is attempted. Also, the damage or broken component may not be easily identified, which requires further troubleshooting and in some instances disassembly of the keyboard to try to locate the damaged or destroyed components.

Thus, in light of the above, there is need for a keyboard to remedy any of the issues described above.

What is therefore further needed is an improved keyboard that can quickly, easily, and affordably be customized. More specifically, what is needed is a keyboard having various components that can quickly and easily be installed or uninstalled to result in a customized keyboard. What is also needed is a keyboard system and kit containing various components to enable tool-less or otherwise simplified customization of the keyboard.

### SUMMARY OF THE INVENTION

In accordance with an aspect of the present invention, a convertible keyboard is provided that includes a base, a plurality of keycaps releasably secured to the base, a first adapter, and a second adapter. The first adapter is configured to be releasably secured to the base about the plurality of keycaps. Also, the first adapter may have a first profile. The second adapter is also configured to be releasably secured to the base about the plurality of keycaps. The second adapter has a second profile, where the first profile is greater than the second profile. Thus, the second adapter may be a low-profile adapter that creates a low-profile appearance when secured to the base, and the first adapter may be a high-profile adapter that creates a high-profile appearance when secured to the base.

In accordance with another aspect of the invention, the base is configured to receive one of the first adapter and the second adapter at a time. For instance, the adapters may be configured for quick release from the base. In one embodiment, magnets may be used to secure the adapters to the base. For example, a first plurality of magnets may be included with the first adapter, and a second plurality of magnets may be included with the second adapter. In another embodiment, snap fit components may be included, such that a first snap fit configuration is provided with the first adapter, and a second snap fit configuration is provided with the second adapter. In yet another embodiment, clasps may be used, with at least one clasp associated with the first adapter and at least one other clasp associated with the second adapter. Of course, the adapters could similarly have multiple magnets, snap fits, clasps, or any other components to enable expedient connection and disconnection of the adapters relative to the base.

According to another aspect of the present invention, the first adapter may further comprise a first perimeter wall and a first plurality of pillars extending downwardly from the first perimeter wall. The second adapter further comprises a second perimeter wall and a second plurality of pillars extending downwardly from the perimeter wall. The first plurality of pillars may be configured to releasably attach the first adapter to the base, whereas the second plurality of pillars may be configured to releasably attach the second adapter to the base. For instance, one or more of magnets, snap fits, clasps and the like may be associated with the pillars in certain embodiments. In other embodiments, a threaded opening is formed in one or more of the pillars. Additionally, openings may be formed in the base, such that a plurality of screws can be inserted through the plurality of openings formed in the base and into the threaded openings formed in each of the plurality of pillars.

According to another aspect of the present invention, a method of assembling a convertible keyboard is provided. The method may include selecting a first adapter and releasably installing the first adapter relative to a base with a plurality of keycaps. Thereafter, the first adapter may be removed from the base, after which a second adapter may be selected and then releasably installed relative to the base. The first adapter may be a high-profile adapter having a first height, the second adapter may be a low-profiled adapter having a second height, where the first height is greater than the second height. The first adapter and the second adapter may be releasably installed relative to the base with or without tools. In one embodiment, the method also includes engaging a first plurality of magnets associated with the first adapter with a second plurality of magnets associated with the base. Thereafter, the first plurality of magnets may be disengaged from the second plurality of magnets associated with the base, such that the first adapter is released. Next, a third plurality of magnets associated with a second adapter may be engaged with the second plurality of magnets associated with the base. Again, the third plurality of magnets can then be disengaged from the second plurality of magnets in order to release the second adapter from the base.

Additionally, in another aspect the present invention is directed to a keyboard kit. The kit includes a convertible keyboard having a base and a plurality of keys, as well as first and second adapters, both of which are configured to be releasably attached to the keyboard. Additionally, the kit may include a plurality of lights that may be secured to any of the components associated with the keyboard. The plurality of keys may also be releasable connected to the base. The kit may also include tools to facilitate assembly of the keyboard.

These and other aspects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof. It is hereby disclosed that the invention include all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an exploded isometric view of a convertible keyboard including multiple adapters that can quickly and easily be installed relative to a base and keys to result in a customizable appearance;

FIG. 2A is an exploded isometric view of the convertible keyboard of FIG. 1 with a first adapter spaced from the base and keys with arrows indicating assembly of the first adapter relative to the other components of the keyboard;

FIG. 2B is an exploded isometric view of an alternative embodiment of the convertible keyboard of FIG. 1 with a first adapter spaced from the base and keys;

FIG. 2C is an exploded isometric view of another alternative embodiment of the convertible keyboard of FIG. 1 with a first adapter spaced from the base and keys;

FIG. 3 is an assembled isometric view of the convertible keyboard of FIG. 2A;

FIG. 4 is a first side elevation view of the assembled convertible keyboard of FIG. 3;

FIG. 5 is a second side elevation view of the assembled convertible keyboard of FIGS. 3 and 4;

FIG. 6 is a bottom isometric view of the convertible keyboard of FIGS. 3-5;

FIG. 7 is an exploded isometric view of the convertible keyboard of FIG. 1 with a second adapter spaced from the base and keys with arrows indicating assembly of the second adapter relative to the other components of the keyboard;

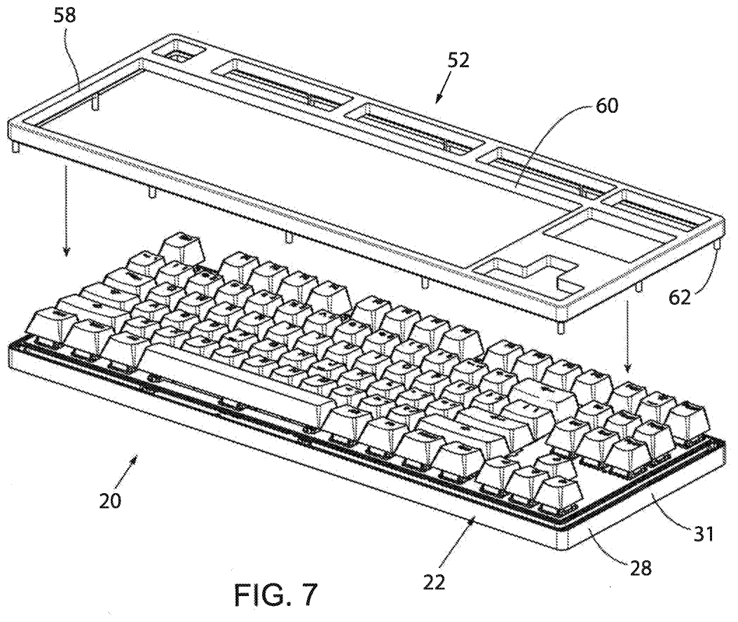

FIG. 8 is an assembled isometric view of the convertible keyboard of FIG. 7;

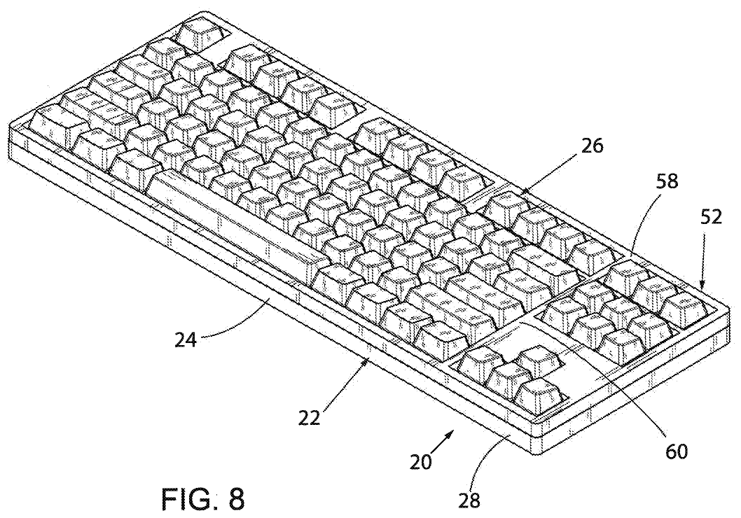

FIG. 9 is a first side elevation view of the assembled convertible keyboard of FIG. 8; and

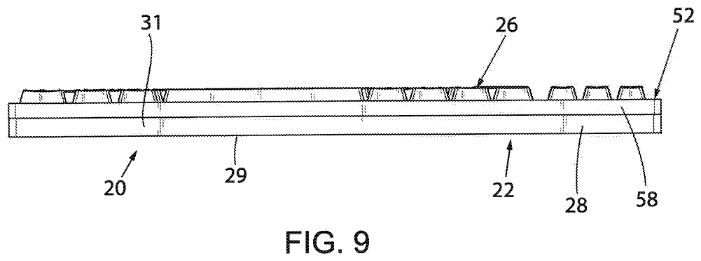

FIG. 10 is a second side elevation view of the assembled convertible keyboard of FIGS. 8 and 9.

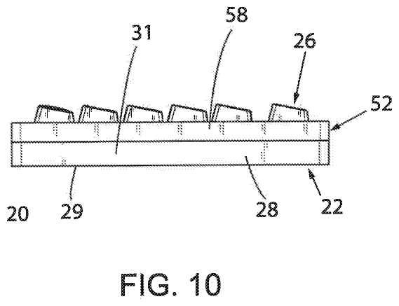

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

1. System Overview

The present invention enables a user to modify the aesthetic, sound, and typing feel of a keyboard without requiring the disassembly or partial disassembly of any core aspects of the keyboard. In order to achieve a similar customized keyboard, in the past users would need to either purchase multiple different keyboards and/or perform onerous deconstruction that would take hours of work. This prior art deconstruction would also expose a variety of electrical components of the keyboard and PCB, as well as other structural areas, to damage.

In contrast, the present invention presents a singular keyboard with a variety of components to enable quick and easy customization. By way of example and not limitation, one such customization would be a singular keyboard convertible between both high-profile or low-profile appearance without needing a separate keyboard or extensive modification. A user may quickly and easily move back and forth between multiple different low-profile and high-profile configurations, as may be desired. This allows consumers to quickly and easily convert a high-profile keyboard that is typically optimized for typing feel and sound, to a low-profile keyboard that is typically optimized for gaming while also allowing for underlighting.

These customizations can be quickly accomplished in seconds, if not minutes, in many cases without use of any external tools not included with the keyboard. For instance, the appearance of the keyboard of the present invention can be changed in less than 5-30 seconds in certain embodiments, and in less than 1-2 minutes in other embodiments, as will be further described below.

2. Detailed Description of Preferred Embodiments

As shown in the figures, the present invention is directed to a customizable keyboard as generally referred to as reference number 20. Although the primary embodiment shown in the figures is directed to a tenkeyless (TKL) keyboard without a numeric pad, the inventive keyboard could similarly be directed to other keyboards, including but not limited to a full-sized keyboard, 65% keyboard without the numeric pad or the F keys, 60% keyboard without numeric pad or F keys or directional arrow keys, a 75% keyboard without the numeric pad, or any other keyboard as desired by a given user.

The inventive keyboard 20 includes a number of common components, including a base 22, various hardware 24, keycaps/switches 26, and various adapters. While each of these components will be further described below, it should be noted that the inventive keyboard 20 may include additional components that may be functional in nature, non-functional in nature but rather for the purposes of visual and other customizable appearances, or serve both functional and non-functional purposes. Similarly, all of the components described herein are not required to be included in the inventive keyboard. For instance, any of the hardware 24 or the keycaps/switches may be included in certain embodiments of the keyboard 20, but not included in others. The adapters are configured to enable the appearance, as well as the associated functionality of the keyboard 20, to be quickly and easily changed based on the preference of the user.

Initially, the base 22 will be described. As shown, the base 22 includes a lower case 28 having a bottom 29 and a sidewall 31 extending therefrom to form a cavity 33 configured to receive many of the remaining components while providing structural rigidity to the keyboard 20. In one embodiment, the lower case 28 is made of aluminum, while in other embodiments, the lower case 28 is made of any other metallic or plastic material that has sufficient rigidity while also being affordable, easy to manufacture, and lightweight.

On the underside of the bottom 29 of the lower case 28, a plurality of adjustable feet 30 are provided that can be pivoted between extended and non-extended positions. In the extended position, one end of the adjustable feet 30 are rotated away from the underside of the bottom 29 of the lower case 28 such that the one end of the adjustable feet 30 contacts the operating surface in order to place the keyboard 20 at an operating angle. As the name suggests, the adjustable feet 30 may also be configured to allows the height of the feet 30 to be adjusted, which in turn adjusts the overall angle of the keyboard 20 relative to the operating surface such that the keyboard 20 can be positioned as desired by the user. For instance, multiple feet may be provided, with one set of feet having a first height and the second set of feet having a second height. The feet 30 may be made of plastic, aluminum, other metal materials, or any other durable material that provides sufficient traction to prevent movement of the keyboard 20 while a user types on the keycaps/switches 26.

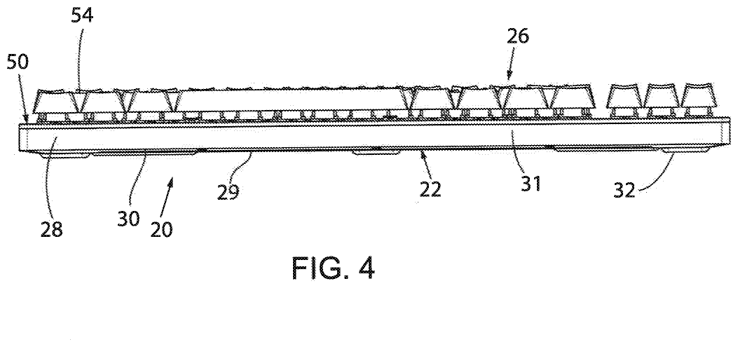

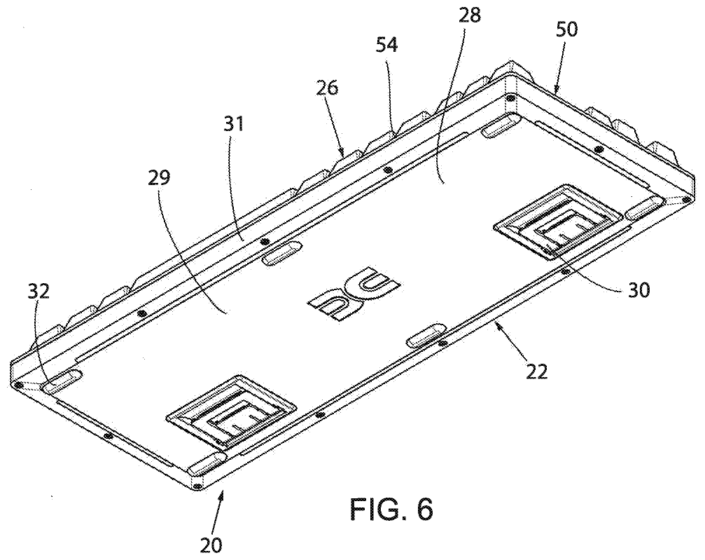

In the non-extended position shown in FIGS. 4 and 6, the feet 30 are nested and rest substantially against the underside of the lower case 28 so as to not directly support the keyboard 20. Such a configuration would allow the keyboard 20 to be rested substantially parallel with the supporting surface. This is particularly appealing when the keyboard 20 is being shipped or otherwise transported from one location to another or stored due to the minimized side profile.

Additionally, the lower case 28 may include a plurality of support pads 32 affixed to the bottom 29. As shown, support pads 32 are located around the perimeter of the lower case 28, with four support pads being located at the respective corners of the bottom 29 of the lower case 28, and two being located midway between the width of the lower case 28. The support pads 32 are also configured to contact the support surface. Preferably, the support pads 32 are made of a material having sufficient traction in order to help ensure the keyboard 20 is held in place relative to the support surface, while also providing some flexibility when a user is pressing the keys/switches 26 in order to transfer the force exerted onto the keyboard 20 onto the supporting surface without damaging the lower case 28 or any other element of the keyboard 20. Further, logos, branding, and any other desired design elements may be formed in the lower case 28, for instance in the bottom 29 as shown in FIG. 6.

The base 22 also includes a lower case insert 34. As shown, the lower case insert 34 is nested directly into the cavity 33 formed between the bottom 29 and sidewall 31 of the lower case 28 and releasably secured to the lower case 28. For instance, the lower case insert 34 may be snap fit into the lower case 28, although it could similarly be clipped, glued, screwed, bolted, or secured to the lower case 28 in any other way as known to those having ordinary skill in the art. Of course, the lower case 28 and the lower case insert 34 could similarly be formed together. The illustrated embodiment shows a lower case insert 34 made of plastic, although again any other metallic or other material could similarly be used as may be desired. The lower case insert 34 has a perimeter 35 configured to fit within the lower case 28, as well as protrusions 36 that extend upwardly from the lower case 28. The protrusions 36 are configured to interact with other components as will further be described below, and to secure the other components into place relative to the lower case insert 34, and the lower case 28 by extension, More specifically, other components may be releasably secured to the protrusions 36 as will further be described herein.

Next, a lower case foam layer 38 and a lower case rubber gasket 40 are provided. Both of these components are configured to be overlaid directly onto the lower case insert 34 and within the cavity 33 of the lower case 28. As can be seen in the figures, the foam layer 38 extends across a substantial amount of the lower case 28, whereas the lower case rubber gasket 40 extends around the perimeter of the lower case 28. As the names suggest, both the lower case foam layer 38 and the lower case rubber gasket 40 are made of shock and sound absorbing materials such that both absorb forces applied to the overlying components such as the key-caps/switches 26. While these components are described as being foam or rubber in material, they could similarly be made of other materials having similar characteristics.

Additionally, one or more components capable of providing various lighting displays are provided. For instance, as shown a series of underglow lights 42 may be provided that are mounted to the keyboard 20 and associated components. Additionally, a hotswappable dual USB-C 44 may be provided having additional lights. Both of these lights 42, 44 may have a combination of red, green, and blue components which can be toggled to achieve any desired color combination. Of course, any other lighting components could similarly be employed within the keyboard 20 or extending from the keyboard 20.

Next, a printed circuit board upper foam layer 46 is provided. This printed circuit board upper foam layer 46 may be configured to overlie the hotswappable dual USB-C component 44 within the cavity 33 of the lower case 28. This foam layer 46 may provide additional shock absorption and other features as may be desired. Next, an iron plate layer 48 may be rested on top of the printed circuit board upper foam layer 46, again within the cavity 33 of the lower case 28. Although described as an iron plate layer 48, this component could similarly be made of any number of other materials as desired by a user, including but not limited to other metals such as brass or aluminum, plastics such as polycarbonate, ABS and the like, as well as carbon fibers. As can be seen in the figures, the printed circuit board upper foam layer 46 and the iron plate layer 48, as well as the USB-C component 44 may be substantially the same shape of a traditional keyboard, with cutouts being formed therein where each of the keys are located.

The keyboard 20 also includes a plurality of keycaps and switches 26. As described above, the specific configuration of the keycaps and switches 26 could vary depending on the specific use of the keyboard 20 and desired physical appearance. For instance, the keys may be directed to a tenkeyless (TKL) keyboard without a numeric pad, but the keys could also include a full-sized keyboard, a 65% keyboard without the numeric pad or the F keys, a 75% keyboard without the numeric pad, or any other keyboard as desired by a given user. Additionally, the keycaps and switches 26 may be quickly and easily installed and uninstalled/replaced to enable a user to customize the appearance of the keyboard 20 by utilizing different keycaps and switches 26. For instance, keycaps and switches 26 having any number of different characteristics, including color, lights, height, images, and the like could be swapped in and out as desired by a user. These keycaps and switches 26 can be snapped into place, in which case all of the intervening layers between the keycaps and switches 26 and lower case 26 are secured into place. Of course, the keycaps and switches 26 could also be clipped into place, or otherwise secured with or without tools, for instance with screws, bolts, or other fasteners.

In addition to the various components described above, the keyboard 20 also includes one or more adapters that are configured to be quickly and easily releasably attached to the base 22 and/or any other components of the keyboard 20. As shown, the illustrated embodiment includes a low-profile adapter 50 and a high-profile adapter 52, although adapters having different heights and other characteristics such as colors and lights could similar be included with or installed relative to the keyboard 20. Initially, the low-profile adapter 50 will be described.

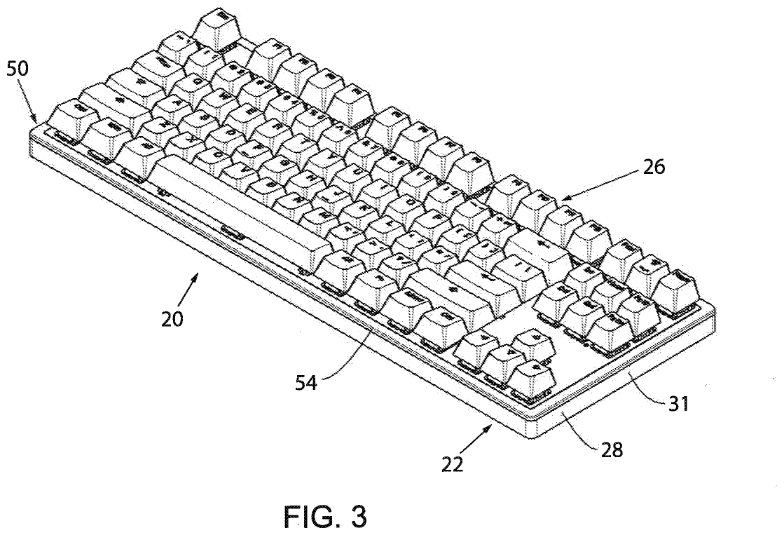

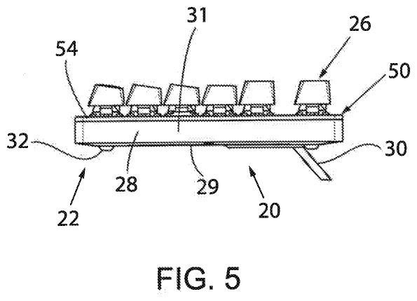

As the name implies, the low-profile adapter 50 is configured to be releasably secured to the keyboard 20 to achieve the appearance of a low-profile keyboard, which is best seen in FIGS. 3-6. As described above, such a keyboard 20 allows a greater proportion of the keycaps 26 to extend above the profile of the assembled keyboard 20, which may be particularly appealing where the keyboard 20 is used in connection with gaming. For instance, a low-profile keyboard may be defined as a keyboard in which part or all of the switches of the keycaps are exposed when viewing the keyboard from the side. By way of example and not limitation, the height of the low-profile adapter 50 that extends above the base is preferably between 1-4 millimeters, and more preferably between 1.5-3.5 millimeters, and in the illustrated embodiment preferably between approximately 2-3 millimeters. However, again these numbers should not be construed as limiting. Alternatively still, no adapter could be applied at all, with the resulting keyboard 20 have a low profile appearance based on the lack of an adapter.

The illustrated low-profile adapter 50 is substantially rectangular is shape, and of a perimeter design with four side walls 54 extending around the perimeter of the keycaps 26. Of course, the low-profile adapter 50 could similarly include additional sides, walls, and the like, for instance separate walls configured to surround and separate various keycaps, such as the “F” keys located toward the top of certain keyboards, as well as any other keys outside of the standard QWERTY keyboard, like what is shown and described below in connection to the high-profile adapter 52. In addition to the sides, the low-profile adapter 50 includes a plurality of leg pillars 56 that extend substantially perpendicular to the side wall 54. These pillars 56 are configured to help contact the other portions of the keyboard 20 in order to secure the low-profile adapter 50 to the base 22 of the keyboard 20. These pillars 56 may be secured to the base 22 in any number of different ways, as will be further described below. As shown, twelve pillars 56 are provided including three extending downwardly from either lateral side wall, and three extending downwardly from the top and bottom side walls. Of course, additional or few pillars may be provided as desired. Similarly, certain embodiments of the adapter 50, 52 do not include pillars at all, but are mounted to the keyboard 20 using any of the magnets, clips, clasps, or other securement devices described herein.

Additionally, as the name implies, the high-profile adapter 52 is configured to be releasably secured to the keyboard 20 to achieve the appearance of a high-profile keyboard. Such a keyboard 20 creates a different profile view by having a smaller proportion of each respective keycaps 26 extending upwardly above the high-profile adapter 52, which in turn creates a different visual appearance in comparison to the low-profile keyboard described above. For instance, a high-profile keyboard may be defined as a keyboard in which the switches of the keycaps are completely or partially protected. A high-profile keyboard may also be defined as a keyboard in which the keycaps are not visible or only partially visible when viewing the keyboard from the side. By way of example and not limitation, the height of the high-profile adapter 52 that extends above the base is preferably between 6-11 centimeters, and more preferably between 7-9 centimeters, and in the illustrated embodiment preferably between approximately 8-9 millimeters. However, again these numbers should not be construed as limiting.

The illustrated high-profile adapter 52 is substantially rectangular in shape, and includes four perimeter walls 58, as well as interior walls 60 that are configured to surround various portions of the keys. For instance, as shown, the various sets of keycaps 26 are surrounded on the interior by interior walls 60 of the high-profile adapter 52, while the perimeter walls 58 extend around the exterior edges of the keycaps 26. Further still, the high-profile adapter 52 could simply extend around the perimeter of the keyboard 20 akin to the low-profile adapter described above. Again, in addition to the walls 58, 60, the high-profile adapter 52 includes a plurality of leg pillars 62 that extend substantially perpendicular to the walls 58, 60. These pillars 62 are configured to help contact the other portions of the keyboard 20 in order to secure the high-profile adapter 52 to the base 22 of the keyboard 20. These pillars 62 may be secured to the base 22 in any number of different ways, as will be further described below. As shown, twelve pillars 62 are provided including three extending downwardly from either lateral side wall, and three extending downwardly from the top and bottom side walls. Of course, additional or few pillars may be provided as desired, or no pillars may be provided where the adapters otherwise connect to the keyboard.

Both the low-profile adapter 50 and the high-profile adapter 52 can be quickly and easily releasably attached to the base 22 of the keyboard 20 in any number of different ways. While some exemplary embodiments will be further described below, these should be interpreted as illustrative in nature and not limiting. Further, multiple adapters may be installed relative to the base 22 of the keyboard 20 at the same time. For instance, the low-profile adapter 50 may initially be installed relative to the base 22, after which the high-profile adapter 52 may be stacked on top of the low-profile adapter 50. Similarly, multiple low-profile adapters 50 could be stacked on top of one another until a desired visual or operational characteristic is achieved.

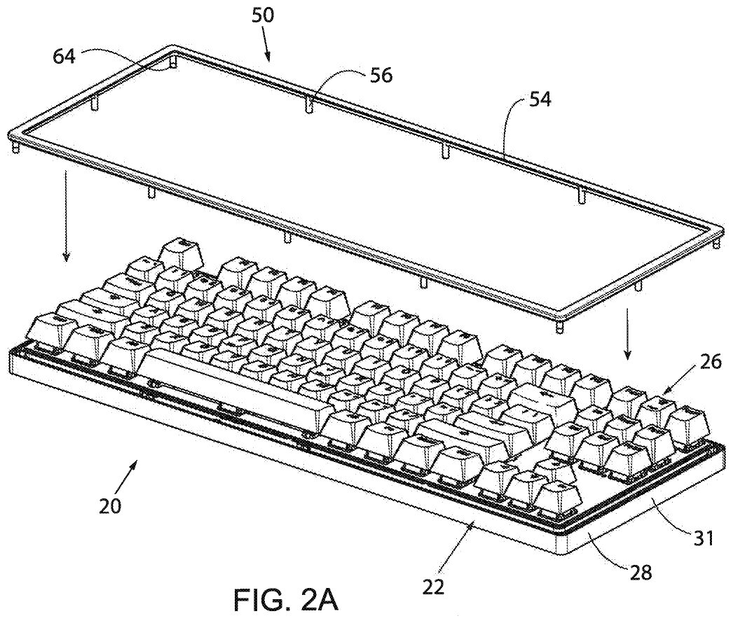

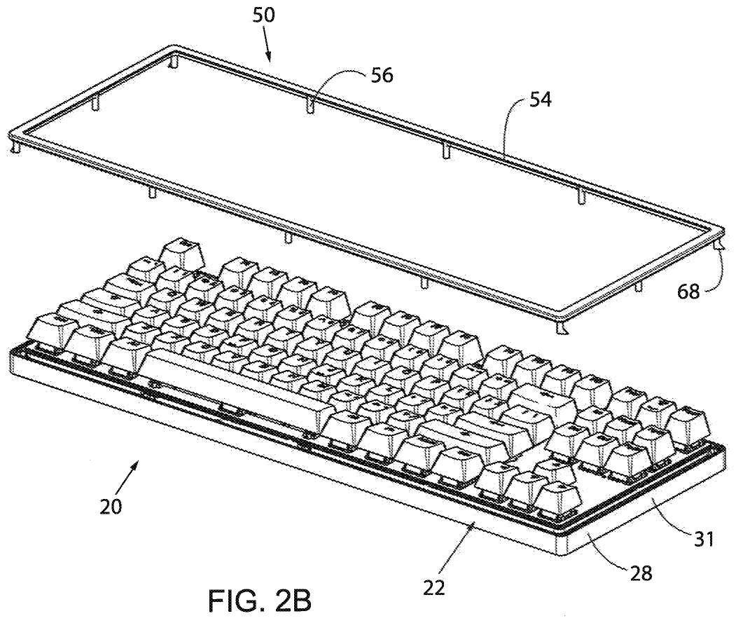

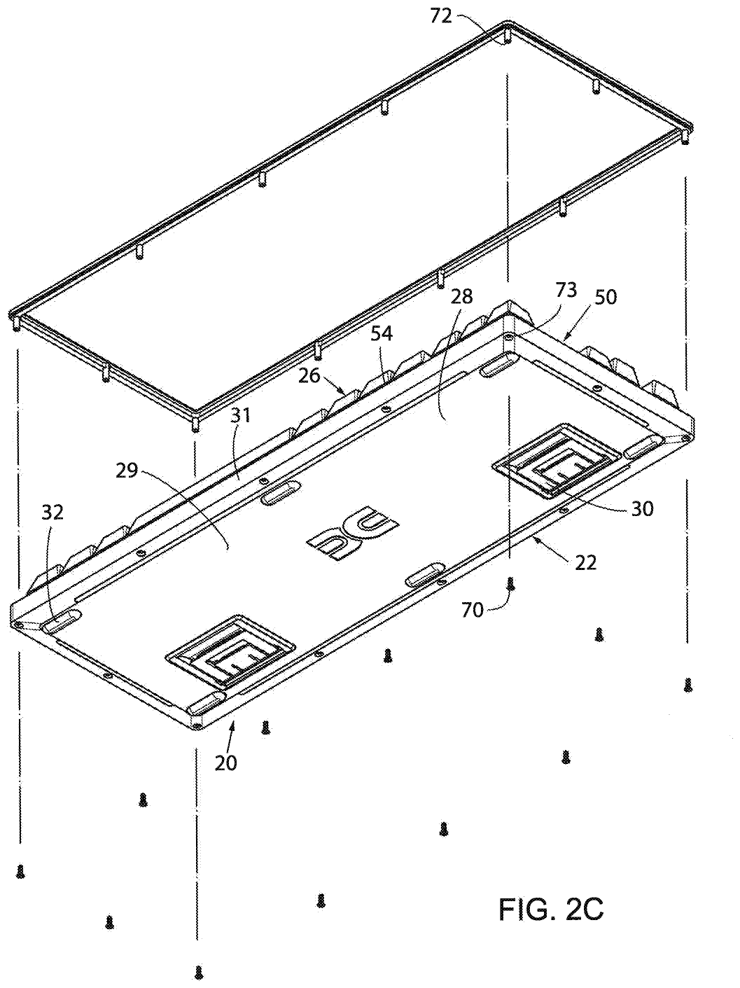

For instance, the pillars 56, 62 of each respective adapter 50, 52 may fasten to or otherwise be secured to the base 22 or other components of the keyboard. In one embodiment, the adapters 56, 62 may be releasably secured to the base 22 or any other component using a plurality of magnets. For instance, a plurality of magnets 64 may be embedded into the underside of each pillar 56, 62 of each adapter 50, 52, with corresponding magnets 66 being formed in the base 22 of the keyboard 20. As shown in FIG. 2A, there are magnets 64 contained in the four corner pillars 56, although magnets could similarly be contained in additional or fewer pillars 56. Again, this allows for the adapters 50, 52 to be installed and uninstalled quickly and easily without interfering with any of the other components associated with the keyboard 20. Additionally, such an embodiment is advantageous in that it does not require any independent tools.

In yet another embodiment, the adapters 50, 52 may be releasably secured to the base 22 of the keyboard 20 using a plurality of clasps or clips. For instance, one or more clasps or clips 68 may be formed with or extend from the pillars 56, 62 of the respective adapters 50, 52, where the clasps or clips 68 are configured to engage with the base 22 of the keyboard 20. This is best seen in FIG. 2B, where again clips are formed in corner pillars 62, although they could similarly be contained in additional or fewer pillars 56. Alternatively, one or more clasps or clips (not shown) may be formed with or extend from the base 22 of the keyboard 20, where the clasps or clips are configured to engage with the adapters 50, 52. Further still, one or more clasps or clips (not shown) may be associated with the adapters 50, 52, and one or more clasps or clips (not shown) may be associated with the base 22 or other component of the keyboard 20, such that the combination of clasps or clips may simultaneously be used to secure the adapters 50, 52 to the keyboard 20.

Additionally, these adapters 50, 52 may be secured to the base 22 of the keyboard 20 using a screw or bolt 70 configuration. In such a configuration, the adapters 50, 52 includes a plurality of threaded opening 72 formed therein. For instance, threaded openings 72 may be formed in the underside of each pillar 56, 62, such that the screw or bolts 70 may be inserted through openings 73 in the base 22 and then screwed into the threaded openings 72. Similarly, the plurality of threaded openings may be formed into other surfaces of the adapters 50, 52, such as the side walls 54, perimeter wall 58, or interior wall 60. As such, when the adapters 50, 52 are attached to the keyboard 20, the screws or bolts 70 are screwed through openings 73 in the base 22 and into the adapters 50, 52. Such screws or bolts can be rotated using a screwdriver, a wrench, or any other tool configured to tighten or, loosen the screws or bolts 70. In certain embodiments, these screws or bolts 70 may be driven directly through the base 22 of the keyboard 20 into the adapters 50, 52, such that none of the other components need to be modified, assembled, or disassembled in order for the adapters 50, 52 to be installed or installed from the keyboard 20. In other embodiments, the screws or bolts 70 may be guided through opening in other components, if desired.

Of course, the adapters 50, 52 may also be equipped with two or more of the magnets, clips, clasps, threaded openings, or any other fastener or attachment devices to enable the adapters 50, 52 to be secured in multiple or alternative ways.

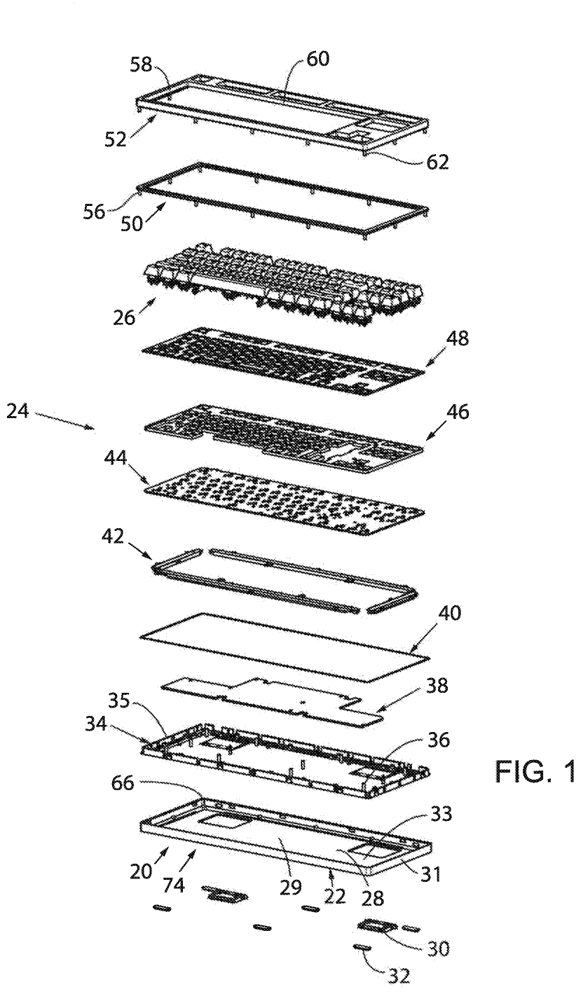

Further still, the present invention is directed to a kit 74 containing some or all of the components above, for instance as shown in FIG. 1. The kit 74 could similarly include additional components, such as alternative adapters, lights, tools for assembly, stickers, labels, and the like. In one embodiment, the kit 74 may include an entire preassembled keyboard 20 that a user can thereafter disassemble and reassemble with different components as may be desired. In other embodiments, the entire base 22 is preassembled, and a user can select between various included keycaps 26 and adapters 50, 52. In yet other embodiments, virtually all of the components can come disassembled, inviting a user to “build your own” keyboard, with a variety of alternative components provided such that a user can select desired components literally from the base up. Expansion packs and other separate components can similarly be sold to further enhance the customizability of the keyboard 20.

Additionally, the present invention is directed to a method of assembling the described keyboard. Below, a variety of steps are provided. However, these steps may occur in a different order, and the method may not include all of the listed steps or may include additional steps. Further, once the keyboard has been assembled, a subset of some but not all of these steps may later be performed to further customize certain aspects of the keyboard. Initially, a keyboard base is provided, along with a number of additional layers. Next, keycaps can be secured to the keyboard base, for instance using a snap fit, clip, or other connector or fastener. After that one of multiple adapters can be selected. Each adapter can be quickly and easily secured to the keyboard base, and each adapter has a slightly different appearance, such as different heights, colors, materials, etc. A first adapter is installed relative to the keyboard, after which it can be uninstalled and replaced with other adapters. In certain embodiments, this uninstallation can be completed without tools, such as when the adapters are mounted using magnets or clips, whereas in other embodiments tools may be required, such as where bolts or screws are used. Other components associated with the keyboard can also be uninstalled and replaced with additional components as desired.

It should be understood that the components of the keyboard may be made of any number of different materials as described above. As stated herein, it is preferred that many of these components are made of metallic and plastic materials, with an emphasis on use of materials that are lightweight, affordably manufactured, and durable. Other materials could similarly be used to improve the operating characteristics of the components. Additionally, while the above description outlines possible ways in which the adapters (and other components for that matter) may be secured to one another, it should be noted that any of the components can be attached to one another using magnets, screws, bolts, clips, rivets, nails, set-screws, tape, glue, adhesive, and the like.

Additionally, it should be understood that the various inventive features described above can each be used independently of one another or in combination with other features.

It is appreciated that many changes and modifications could be made to the invention without departing from the spirit thereof. Some of these changes will become apparent from the appended claims. It is intended that all such changes and/or modifications be incorporated in the appending claims.

What is claimed is:

1. A convertible keyboard comprising;
a base;
a first adapter configured to be releasably secured to the base, the first adapter having a first profile; and
a second adapter configured to be releasably secured to the base, the second adapter having a second profile;
wherein the first profile is greater than the second profile.

2. The convertible keyboard of claim 1, wherein the base is configured to receive one of the first adapter and the second adapter at a time.

3. The convertible keyboard of claim 1, wherein the first adapter and the second adapter are configured for quick release from the base.

4. The convertible keyboard of claim 3, wherein the second adapter is a low-profile adapter creating a low-profile appearance when secured to the base; and
wherein the first adapter is a high-profile adapter creating a high-profile appearance when secured to the base.

5. The convertible keyboard of claim 4, wherein the first adapter further comprises a first plurality of magnets configured to releasably attach to the base; and
wherein the second adapter further comprises a second plurality of magnets configured to releasably attach to the base.

6. The convertible keyboard of claim 4, wherein the first adapter further comprises a first snap fit configured to releasably attach to the base; and
wherein the second adapter further comprises a second snap fit configured to releasably attach to the base.

7. The convertible keyboard of claim 4, wherein the first adapter further comprises at least one clasp configured to releasably attach to the base; and
wherein the second adapter further comprises a second clasp configured to releasably attach to the base.

8. The convertible keyboard of claim 4, wherein the first adapter further comprises:
a first perimeter wall; and
a first plurality of pillars extending downwardly from the perimeter wall;
wherein the second adapter further comprises;
a second perimeter wall; and
a second plurality of pillars extending downwardly from the perimeter wall;
wherein the first plurality of pillars is configured to releasably attach the first adapter to the base; and
wherein the second plurality of pillars is configured to releasably attach the second adapter to the base.

9. The convertible keyboard of claim 8, further comprising:
a threaded opening formed in each of the first plurality of pillars and the second plurality of pillars;
a plurality of openings formed in the base; and
a plurality of screws;
wherein the plurality of screws are configured to be inserted through the plurality of openings formed in the base and into the threaded openings formed in each of the first plurality of pillars and the second plurality of pillars.

10. The convertible keyboard of claim 8, wherein the first plurality of pillars and the second plurality of pillars further comprises one or more of at least one magnet; at least one snap fit, at least one clasp, and at least one threaded opening.

11. A method of assembling a convertible keyboard comprising the steps of:
selecting a first adapter;
releasably installing the first adapter relative to a base with a plurality of keycaps;
selecting a second adapter; and
releasably installing the second adapter relative to the base.

12. The method of claim 11, wherein the first adapter is a high-profile adapter having a first height;
wherein the second adapter is a low-profile adapter having a second height;
wherein the first height is greater than the second height.

13. The method of claim 11, wherein the first adapter and the second adapter are releasably installed relative to the base without tools.

14. The method of claim 11, further comprising the steps of:
engaging a first plurality of magnets associated with the first adapter with a second plurality of magnets associated with the base;
disengaging the first plurality of magnets from the second plurality of magnets associated with the base;
engaging a third plurality of magnets associated with the second adapter with the second plurality of magnets associated with the base; and
disengaging the third plurality of magnets from the second plurality of magnets associated with the base.

15. The method of claim 11, further comprising the steps of:
releasably installing the first adapter relative to a base with a plurality of keycaps;
selecting a second adapter; and
releasably installing the second adapter on top of the first adapter relative to the base.

16. A keyboard kit comprising:
a convertible keyboard comprising a base;
a first adapter having a first profile, the first adapter configured to be releasably attached to the convertible keyboard; and
a second adapter having a second profile, the second adapter configured to be releasably attached to the convertible keyboard.

17. The keyboard kit of claim 15, wherein the first adapter is a low-profile adapter creating a low-profile appearance when secured to the base;
wherein the second adapter is a high-profile adapter creating a high-profile appearance when secured to the base; and
wherein the high-profile adapter has a greater vertical height than the low-profile adapter

18. The keyboard kit of claim 15, further comprising a plurality of lights configured to be releasably attached to one of the bases, the first adapter and the second adapter.

19. The keyboard kit of claim 15, wherein a plurality of keys is releasably connected to the base.

20. The keyboard kit of claim 15, further comprising a plurality of tools configured to assemble the convertible keyboard.
